(19) United States
(12) Patent Application Publication
(10) Pub. No.: US 2025/0392211 A1
(43) Pub. Date: Dec. 25, 2025

(54) LOW POWER STANDBY MODE WITH POWER PATH REUSE

(71) Applicant: Texas Instruments Incorporated, Dallas, TX (US)

(72) Inventors: Abhijeet Godbole, BANGALORE (IN); Koshal Sharma, BANGALORE (IN)

(21) Appl. No.: 18/753,025

(22) Filed: Jun. 25, 2024

(51) Int. Cl. H02M 3/07; H02M 1/00; H02M 1/08; H02M 1/32

(52) U.S. Cl. CPC H02M 3/07; H02M 1/0032; H02M 1/007; H02M 1/08; H02M 1/32

(57) ABSTRACT

Described embodiments include a power path protection circuit having a controller circuit with a gate drive terminal, a converter input terminal, and a converter output terminal. The controller circuit includes a charge pump circuit having a charge pump input and a charge pump output. The charge pump output is coupled to the gate drive terminal. A transistor is coupled between a battery supply terminal and the converter output terminal, and has a control terminal. The control terminal is coupled to the gate drive terminal. A resistor is coupled between the battery supply terminal and the converter input terminal. A voltage clamp circuit is coupled between the converter input terminal and a ground terminal. The charge pump circuit includes first, second and third charge pump stages, all cascaded in series.

### BACKGROUND

This description relates to the implementation of a low power standby mode. One example application that may require a low power standby mode is a power converter with a surge stopper circuit. Typical applications for a surge stopper circuit having a low power standby mode include automotive, power converters, and motor driver applications. For these applications, a typical requirement is that the surge stopper circuit be active and protecting downstream electronics both during normal operation and while the circuit is operating in a low power mode.

An unsuppressed load dump is a large voltage spike that may occur if the automobile's battery is electrically disconnected while the automobile engine is running. An unsuppressed load dump can produce voltage spikes as high as 100V when using a 12V battery, or as high as 200V voltage spikes when using a 24V battery. Some automobiles have a central voltage clamp on the alternator to suppress load dump voltages. However, to be compatible with automobiles that do not have a central clamp on the alternator, many power converters for these types of applications are designed to withstand an unsuppressed load dump without sustaining damage to downstream electronic circuits.

### SUMMARY

In a first example, a power path protection controller includes a controller circuit having a gate drive terminal, a converter input terminal, and a converter output terminal. The controller circuit includes a charge pump circuit having a charge pump input and a charge pump output. The charge pump output is coupled to the gate drive terminal.

A transistor is coupled between a battery supply terminal and the converter output terminal, and has a control terminal. The control terminal is coupled to the gate drive terminal. A resistor is coupled between the battery supply terminal and the converter input terminal. A voltage clamp circuit is coupled between the converter input terminal and a ground terminal. The charge pump circuit includes a first charge pump stage, a second charge pump stage, and a third charge pump stage that are all cascaded in series. The first charge pump stage can be enabled without enabling the second charge pump stage and the third charge pump stage.

In a second example, a control circuit includes an input voltage terminal, and a drive circuit having a drive input and a drive output. A high boost circuit has a high boost input and a high boost output. The high boost input is coupled to the input voltage terminal, and the high boost output is coupled to the drive input. A low boost circuit has a low boost input and a low boost output. The low boost input is coupled to the input voltage terminal, and the low boost output is coupled to the drive input. A voltage that is provided at the low boost output is lower than a voltage provided at the high boost output.

### BRIEF DESCRIPTION OF THE DRAWINGS

FIG. 1 shows a schematic diagram for an example power path protection controller with a surge stopper circuit.

FIG. 2 shows a schematic diagram for an example power path protection controller with a surge stopper circuit that remains active while in standby mode.

FIG. 3 shows a block diagram for an example power path protection controller having a surge stopper circuit that remains active while in standby mode without an added transistor.

FIG. 4 shows a block diagram for a first example charge pump circuit for a power path protection controller having a surge stopper circuit that remains active in standby mode without an added transistor.

FIG. 5 shows a block diagram for a second example charge pump circuit for a power path protection controller having a surge stopper circuit that remains active in standby mode without an added transistor.

### DETAILED DESCRIPTION

In this description, the same reference numbers depict same or similar (by function and/or structure) features. The drawings are not necessarily drawn to scale.

Automotive and industrial equipment can be subjected to line overvoltage conditions and voltage spikes. Input front end protection is used to protect electronic circuits that are downstream from the power converter module from such spikes and overvoltage events. For example, some automobiles include a surge stopper circuit to provide protection against voltage spikes resulting from disconnecting the battery from the automobile electrical circuit.

However, many automobiles and aftermarket automotive equipment do not include a surge stopper circuit. Not having a surge stopper circuit can lead to an unsuppressed load dump being passed on to downstream electronics if the automobile's battery is electrically disconnected while its engine is running. An unsuppressed load dump can produce voltage spikes as high as 100V when operating with a 12V battery, or 200V voltage spikes when operating with a 24V battery. So, to allow their usage in systems both with and without a surge stopper circuit, power converters for many automotive and industrial applications are typically designed to withstand an unsuppressed load dump without damaging downstream electronic circuits.

An unsuppressed load dump can occur in vehicles having no centralized voltage clamping on the alternator. Whenever a vehicle with an internal combustion engine is running, the vehicle's alternator is operating, generating electrical charge and providing it to the battery. If the electrical connection between the alternator and the battery is removed while the alternator is running, the energy stored in the alternator has no path to discharge, and a large voltage spike may result. That voltage spike can be propagated to downstream electronics and may damage them. For this reason, a centralized voltage clamp is sometimes added that clamps the alternator voltage to a safe voltage (e.g. 25V for a 12V battery system).

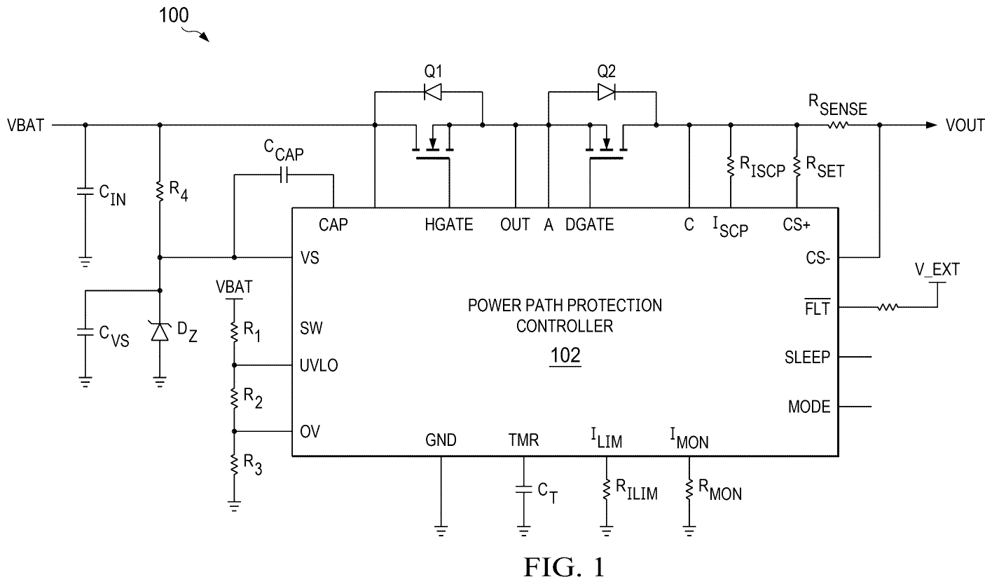

FIG. 1 shows a schematic diagram 100 for an example power path protection controller 102 with a surge stopper circuit. Power path protection controller 102 has an HGATE terminal coupled to the gate of transistor Q1. The HGATE terminal provides a gate drive signal to control transistor Q1. The drain of transistor Q1 is coupled to a DC battery voltage terminal VBAT.

Capacitor C_{IN} is coupled between the DC battery voltage terminal VBAT and a ground terminal. Resistor R₄ is coupled in series with zener diode D_{Z} between the DC battery voltage terminal VBAT and the ground terminal. Capacitor C_{VS} is coupled in parallel with zener diode D_{Z}. The terminal connecting resistor R₄ to zener diode D_{Z} is coupled to a supply voltage terminal VS of power path protection controller 102.

Power path protection controller 102 has a DGATE terminal coupled to the gate of transistor Q2. The DGATE terminal provides a gate drive signal to control transistor Q2. The source of transistor Q2 is coupled to the source of transistor Q1. The drain of transistor Q2 is coupled to a first terminal of a resistor R_{SENSE} that is used for current sensing. The second terminal of resistor R_{SENSE} is coupled to the output voltage terminal VOUT. In at least one example, transistor Q1 and transistor Q2 are each n-channel field effect transistors (FETs).

Resistor R₁ is coupled between the DC battery voltage terminal VBAT and an undervoltage threshold input UVLO. Resistor R₂ is coupled between the undervoltage threshold input UVLO and an overvoltage threshold input 0V. Resistor R₃ is coupled between the overvoltage threshold input 0V and the ground terminal. When the voltage at the undervoltage threshold input UVLO falls below a particular undervoltage cut-off threshold, the voltage at the HGATE terminal is pulled low, turning off transistor Q1. When the voltage at the overvoltage threshold input 0V exceeds a particular overvoltage threshold, the voltage at the HGATE terminal is pulled low, turning off transistor Q1.

In the event of a voltage surge at the DC battery voltage terminal VBAT, the voltage at the supply voltage terminal VS is clamped by zener diode D_{Z}. The breakdown voltage of zener diode D_{Z} is selected to prevent damage to the device, and the remaining voltage from the voltage surge is dropped across resistor R₄. Zener diode D_{Z} operates as a voltage clamp circuit, and can be replaced with a different type of voltage clamp circuit. The overvoltage clamp threshold is chosen to be high enough that transistor Q1 is operated in the cutoff region, but not high enough to damage power path protection controller 102. This provides an overvoltage clamp and protects downstream electronics in the event of an input transient or voltage spike that is higher in magnitude than what the downstream electronics can withstand without being damaged.

However, when an automobile is parked or the system is turned off, the power path protection controller 102 may be put into a low power standby mode to prevent draining the battery down while the alternator is not running. A typical requirement is that the system consume relatively low current when the system is operating in standby mode while maintaining the output voltage. This is so that particular circuitry can remain active while the system is operating in standby mode.

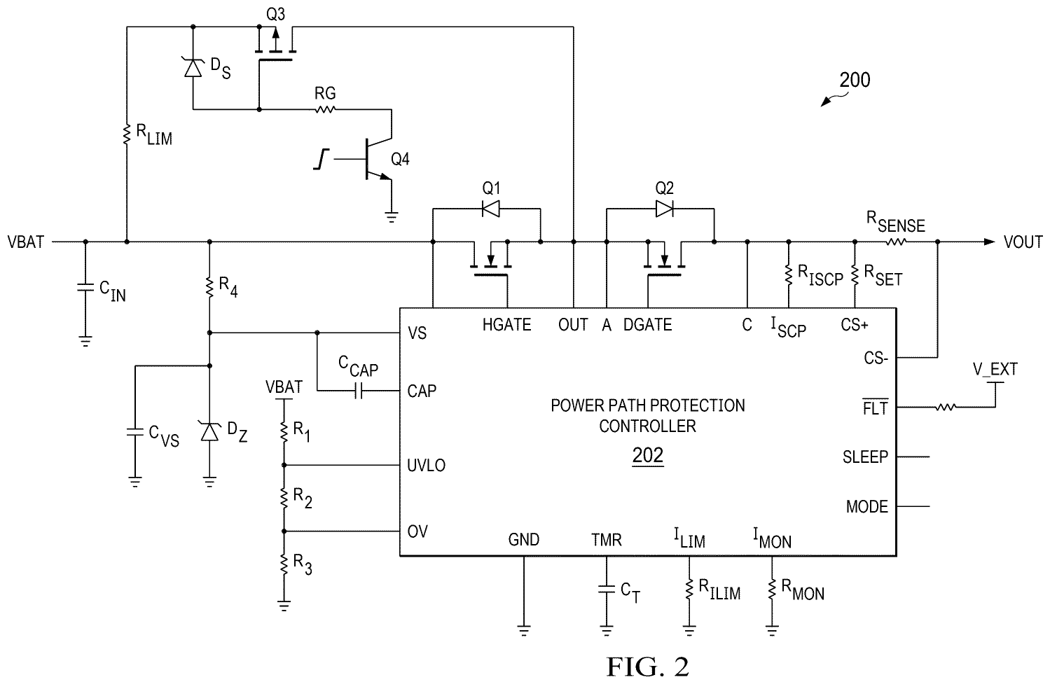

FIG. 2 shows a schematic diagram 200 for an example power path protection controller with a surge stopper circuit that remains active in standby mode. Power path protection controller 202 has an HGATE terminal coupled to the gate of transistor Q1. The HGATE terminal provides a gate drive signal for controlling transistor Q1. The drain of transistor Q1 is coupled to a DC battery voltage terminal VBAT.

Capacitor C_{IN} is coupled between the DC battery voltage terminal VBAT and a ground terminal. Resistor R₄ is coupled in series with zener diode D_{Z} between the DC battery voltage terminal VBAT and the ground terminal. Capacitor C_{VS} is coupled in parallel with zener diode D_{Z}. The terminal connecting resistor R₄ to zener diode D_{Z} is coupled to a supply voltage terminal VS of power path protection controller 202.

Power path protection controller 202 has a DGATE terminal coupled to the gate of transistor Q2. The DGATE terminal provides a gate drive signal for controlling transistor Q2. The source of transistor Q2 is coupled to the source of transistor Q1. The drain of transistor Q2 is coupled to a first terminal of a resistor R_{SENSE} that is used for current sensing. The second terminal of resistor R_{SENSE} is coupled to the output voltage terminal VOUT. In at least one example, transistor Q1 and transistor Q2 are each n-channel FETs. However, in other examples, transistors Q1 and Q2 may be other types of transistors.

Resistor R_{LIM} has a first terminal coupled to the DC battery voltage terminal VBAT. Transistor Q3 is coupled between the second terminal of resistor R_{LIM} and the source of Q1, and has a control terminal. Zener diode D_{S} has a cathode coupled to the source of Q3 and to the second terminal of R_{LIM}. Zener diode D_{S} has an anode coupled to the control terminal of Q3. Resistor RG has a first terminal coupled to the control terminal of Q3 and to the anode of zener diode D_{S}. Transistor Q4 is coupled between the second terminal of resistor RG and the ground terminal. In at least one example, transistor Q3 is a p-channel FET, and transistor Q4 is an npn bipolar junction transistor (BJT). However, in other examples, transistors Q3 and Q4 may be other types of transistors.

Power path protection controller 202 can be put into a low power standby mode by pulling the voltage at a sleep terminal (SLEEP) low. When power path protection controller 202 is operating in standby mode, its current consumption is relatively low (e.g. 2-3 uA). The standby mode for power path protection controller 202 is enabled by turning on transistor Q3, which provides to the source of transistor Q2 the voltage from the DC battery voltage terminal VBAT at the terminal connecting the source of transistor Q1. Providing this voltage to the terminal connecting the source of transistor Q1 to the source of transistor Q2 causes the body diode of transistor Q2 to conduct. So, when power path protection controller 202 is operating in standby mode, the voltage at the output voltage terminal VOUT is equal to the voltage from the DC battery voltage terminal VBAT minus the voltage drop across the body diode of transistor Q2. That voltage when provided at the output voltage terminal VOUT is usually sufficient to keep the required downstream electronics alive while operating in standby mode.

The current consumption of power path protection controller 202 while operating in standby mode usually remains less than 100 mA while still meeting two important goals of first providing enough power to downstream components to allow performance of critical functions, and second to sense whether power path protection controller 202 needs to wake up and transition out of standby mode operation. Transistor Q3, which in this case is external to power path protection controller 202, and the body diode of transistor Q2 allow both of these goals to be achieved while power path protection controller 202 is operating in standby mode.

When power path protection controller 202 is operating in normal mode, any transient voltage spike that occurs at the DC battery voltage terminal VBAT will be passed on to transistor Q1 and to transistor Q3. So, transistors Q1 and Q3 are scaled to withstand the highest voltage present at the DC battery voltage terminal VBAT, which can be 200V. This requires use of an additional high voltage (i.e. 200V) FET for transistor Q3 in addition to the existing high voltage FET used for transistor Q1.

Transistor Q1 and Q3 are usually external to power path protection controller 202 because a 200V process, if it exists, can make the die size of power path protection controller 202 so large, and therefore costly, as to be impractical for many applications. But, an additional discrete 200V FET can also be expensive and also add significant cost to the system. With a lower voltage system (e.g. 50-60V), it may be practical to integrate the additional FET into power path protection controller 202. However, this integration also adds significant additional cost because the FET is still relatively high voltage, and may add up to 20% to the total die area of power path protection controller 202.

Transistor Q1 is the high side drive transistor for the voltage converter, and as such, must be a high voltage transistor (i.e. 200V FET). Significant cost and power savings can be obtained by having a single high voltage transistor (i.e. Q1) perform the functions of both high voltage transistors (i.e. Q1 and Q3), while still providing a low quiescent current while operating in standby mode, and providing the ability to be awakened from standby mode, without the presence of an additional high voltage transistor (i.e. Q3).

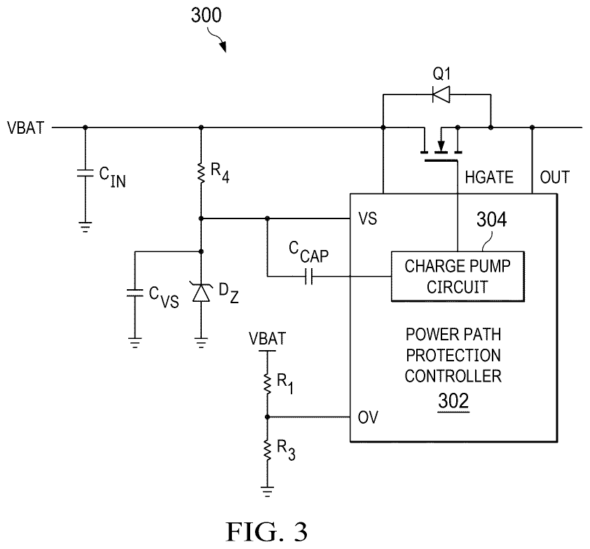

FIG. 3 shows a block diagram 300 for an example power path protection controller 302 having a surge stopper circuit that remains active in standby mode without an additional transistor. power path protection controller 302 has an HGATE terminal coupled to the gate of transistor Q1. The HGATE terminal provides a gate drive signal that controls transistor Q1. The drain of transistor Q1 is coupled to a DC battery voltage terminal VBAT. In at least one example, transistor Q1 is a n-channel FET.

Capacitor C_{IN} is coupled between the DC battery voltage terminal VBAT and a ground terminal. Resistor R₄ is coupled in series with zener diode D_{Z} between the DC battery voltage terminal VBAT and the ground terminal. Capacitor C_{VS} is coupled in parallel with zener diode D_{Z}. The terminal connecting resistor R₄ to zener diode D_{Z} is coupled to a supply voltage terminal VS of power path protection controller 302.

Resistor R₁ is coupled between the DC battery voltage terminal VBAT and an overvoltage threshold input 0V to power path protection controller 302. Resistor R₃ is coupled between the overvoltage threshold input 0V and the ground terminal. Resistor R₁ and resistor R₃ form a voltage divider in which the midpoint of the voltage divider is coupled to the overvoltage threshold input 0V. When the voltage at the overvoltage threshold input 0V exceeds a particular overvoltage threshold, the voltage at the HGATE terminal is pulled low, turning off transistor Q1.

In the event of a voltage surge at the DC battery voltage terminal VBAT, the voltage at the supply voltage terminal VS is clamped by zener diode D_{Z}. The breakdown voltage of zener diode D_{Z} is selected to prevent the device from being damaged. The rest of the voltage surge above the breakdown voltage of zener diode D_{Z} is dropped across resistor R₄. Zener diode D_{Z} operates as a voltage clamp circuit, and can be replaced with a different type of voltage clamp circuit. The overvoltage clamp threshold is chosen high enough that transistor Q1 is operating in the cutoff region, but not high enough to damage power path protection controller 302. This provides an overvoltage clamp and protects downstream electronics from damage whenever there is an input transient or a voltage spike that is higher in magnitude than the voltage the downstream electronics can withstand without being damaged.

Typically, when a FET is fully turned on, the gate voltage of the FET is 12V above the voltage at the source of the FET to completely enhance the FET. In at least one case, the gate drive strength for transistor Q1 is approximately 60-70 uA, which may lead to a quiescent current of around 500 uA for power path protection controller 302. While that current level may be acceptable for normal operation mode, the total current requirement while operating in standby mode is usually significantly lower than that.

Charge pump circuit 304 includes a charge pump and voltage scaling logic circuitry. Charge pump circuit 304 has an input coupled to the supply voltage terminal VS, and has an output coupled to the HGATE terminal, which is also coupled to the gate of transistor Q1. Charge pump circuit 304 scales its charge pump voltage in such a way to keep transistor Q1 turned on. Instead of applying 12V above the voltage at the source of transistor Q1 to the gate of Q1, a smaller voltage (e.g. 5V) that is just above the threshold voltage of transistor Q1 is provided to the gate of transistor Q1 to keep transistor Q1 turned on. Now, less than 10 microamps of drive strength is needed on the gate of transistor Q1 to keep it turned on.

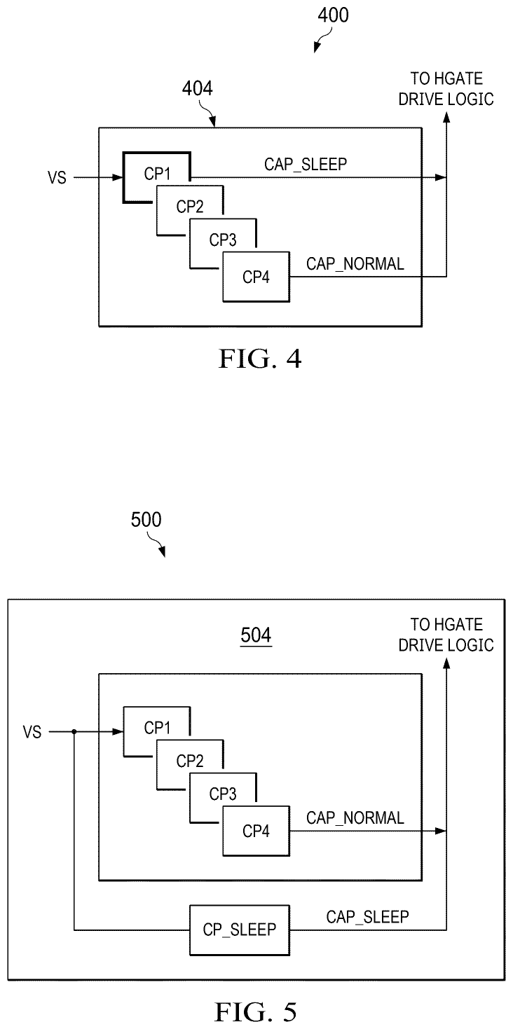

FIG. 4 shows a block diagram 400 for a first example charge pump circuit 404 for a power path protection controller having a surge stopper circuit that remains active in standby mode without an added transistor. Charge pump circuit 404 is a four-stage charge pump that includes stages CP1, CP2, CP3, and CP4. The four stages are cascaded together in series, but, in at least one case, the four stages may be controlled independently. The stages are in series and you turn on the number of stages you need to get the desired drive. Charge pump circuit 404 has four stages in this example, but may have more or less than four stages in other examples.

During normal operation of power path protection controller 302, a relatively high gate drive strength is needed. In this case, all four stages, CP1, CP2, CP3, and CP4, are enabled. However, when power path protection controller 302 is operating in standby mode, high gate drive strength is not needed. Because high gate drive strength is not needed when operating in standby mode, four cascaded charge pump stages are not needed. So, three of the charge pump stages can be disabled and only one charge pump stage can remain active and provide the necessary gate drive strength. In this case, charge pump stage CP1 can be turned on and charge pump stages CP2, CP3, and CP4 can remain turned off. In at least one case, charge pump stages CP2, CP3, and CP4 are controlled together so that all of them are either turned on or turned off together. In at least one other case, charge pump stages CP2, CP3, and CP4 are controlled independently, so that any one, two, or three of them can be turned on or off in combination with charge pump stage CP1.

Output signal CAP_SLEEP and output signal CAP_Normal are connected together and are coupled to the gate drive circuitry providing the HGATE drive signal to the gate of transistor Q1. When power path protection controller 302 is operating in standby mode, only charge pump stage CP1 is active, and the output signal CAP_SLEEP is enabled and is provided to the gate drive circuitry that provides the HGATE drive signal to the gate of transistor Q1. When power path protection controller 302 is operating in standby mode, the output signal CAP_Normal is disabled and remains in a high-impedance state.

When power path protection controller 302 is operating in normal operating mode, charge pump stages CP1, CP2, CP3, and CP4 are all active, and the output signal CAP_Normal is enabled and is provided to the gate drive circuitry providing the HGATE drive signal to the gate of transistor Q1. When power path protection controller 302 is operating in normal operating mode, the output signal CAP_SLEEP is disabled and remains in a high-impedance state. In another example case, some but not necessarily all of charge pump stages CP1, CP2, CP3, and CP4 are active when power path protection controller 302 is operating in normal operating mode.

FIG. 5 shows a block diagram 500 for a second example charge pump circuit 504 for a DC-DC voltage converter having a surge stopper circuit that remains active in standby mode without an added transistor. Charge pump 504 has a four-stage charge pump that is enabled during normal operation of power path protection controller 302, and a separate single-stage charge pump that is enabled during operation of power path protection controller 302 in standby mode.

The four-stage charge pump includes charge pump stages CP1, CP2, CP3, and CP4. These four stages are cascaded together in series. But, in at least one case, the four stages may be controlled independently. The stages are connected in series, and the number of stages needed to get the required gate drive strength are turned on during normal operation of power path protection controller 302. CP_SLEEP is the single-stage charge pump that is enabled when power path protection controller 302 is operating in standby mode. Charge pump stages CP1, CP2, CP3, and CP4 are all disabled when power path protection controller 302 is operating in standby mode. When power path protection controller 302 is operating in normal operating mode, charge pump CP_SLEEP is disabled and charge pump stages CP1, CP2, CP3, and CP4 are enabled.

Output signal CAP_SLEEP is the output of charge pump CP_SLEEP, and output signal CAP_Normal is the output of charge pump stages CP1, CP2, CP3, and CP4. Output signal CAP_SLEEP and output signal CAP_Normal are connected together and are coupled to the gate drive circuitry providing the HGATE drive signal to the gate of transistor Q1. When power path protection controller 302 is operating in standby mode, the output signal CAP_SLEEP is enabled and is provided to the gate drive circuitry that provides the HGATE drive signal to the gate of transistor Q1. When power path protection controller 302 is operating in standby mode, the output signal CAP_Normal is disabled and remains in a high-impedance state.

When power path protection controller 302 is operating in normal operating mode, the output signal CAP_Normal is enabled and is provided to the gate drive circuitry providing the HGATE drive signal to the gate of transistor Q1. When power path protection controller 302 is operating in normal operating mode, the output signal CAP_SLEEP is disabled and remains in a high-impedance state. In another example case, some but not necessarily all of charge pump stages CP1, CP2, CP3, and CP4 are active when power path protection controller 302 is operating in normal operating mode.

When power path protection controller 302 is operating in standby mode, charge pump circuit 304 is switched to a charge pump stage that allows scaling the gate drive voltage provided to transistor Q1 to a lower voltage than in normal operating mode, and also brings the drive strength down to a few uA. In that way, low quiescent current is achieved while keeping transistor Q1 turned on. The quiescent current is reduced, but at the same time, the voltage at the DC battery voltage terminal VBAT is provided to the source of transistor Q1. The body diode of a second transistor Q2 (not shown in FIG. 3) conducts and provides the output voltage to the always-on system. By doing this, no additional high voltage transistor is not needed to provide adequate power to downstream components for critical functions when power path protection controller 302 is in standby mode, and to sense whether power path protection controller 302 needs to wake up and transition out of standby mode.

The example system shown in block diagram 300 enables the use during standby mode operation of the power path transistor Q1 that is already present in the system, eliminating the need for either an external high voltage FET or an integrated high voltage FET. Eliminating the need for an additional high voltage transistor saves system cost and complexity while also providing lower power dissipation during operation in standby mode. Furthermore, it supports providing high voltage surge stopper protection during standby mode without adding any additional components. Compared to existing solutions having a separate power transistor, the power dissipation may be less in some cases because there is not an added power dissipation across the R_{DSon} resistance of the additional FET.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A power path protection controller, comprising:
a controller circuit having a gate drive terminal, a converter input terminal, and a converter output terminal, wherein the controller circuit includes a charge pump circuit having a charge pump input and a charge pump output, in which the charge pump output is coupled to the gate drive terminal;
a transistor coupled between a battery supply terminal and the converter output terminal, and having a control terminal, wherein the control terminal is coupled to the gate drive terminal;
a resistor coupled between the battery supply terminal and the converter input terminal; and
a voltage clamp circuit coupled between the converter input terminal and a ground terminal.

2. The power path protection controller of claim 1, wherein the charge pump circuit includes a first charge pump stage, a second charge pump stage, and a third charge pump stage all cascaded in series, and the first charge pump stage can be enabled without enabling the second charge pump stage and the third charge pump stage.

3. The power path protection controller of claim 2, wherein each of the first, second, and third charge pump stages is enabled during operation in a normal mode, and only the first charge pump stage is enabled during operation in a standby mode.

4. The power path protection controller of claim 1, wherein the charge pump circuit includes a first charge pump circuit and a second charge pump circuit, wherein the first charge pump circuit is a single-stage charge pump circuit, and the second charge pump circuit includes three charge pump stages that are cascaded in series, and the first charge pump circuit and the second charge pump circuit are never concurrently enabled.

5. The power path protection controller of claim 4, wherein the first charge pump circuit is enabled during operation in a standby mode, and the second charge pump circuit is enabled during operation in a normal mode.

6. The power path protection controller of claim 1, wherein the transistor is a field effect transistor (FET) having a source coupled to the converter output terminal, a drain coupled to the battery supply terminal, and a body diode coupled between the converter input terminal and the converter output terminal.

7. The power path protection controller of claim 1, further comprising a capacitor coupled between the converter input terminal and the charge pump input.

8. The power path protection controller of claim 7, wherein the capacitor is a first capacitor, and the power path protection controller is further comprising a second capacitor coupled between the converter input terminal and the ground terminal.

9. The power path protection controller of claim 5, further comprising a voltage divider coupled between the battery supply terminal and the ground terminal and having a divider midpoint terminal, wherein the divider midpoint terminal is coupled to an overvoltage terminal of the power path protection controller.

10. The power path protection controller of claim 3, wherein a voltage at the control terminal is lower during operation in the standby mode than during operation in the normal mode.

11. A control circuit, comprising:
an input voltage terminal;
a drive circuit having a drive input and a drive output;
a high boost circuit having a high boost input and a high boost output, wherein the high boost input is coupled to the input voltage terminal, and the high boost output is coupled to the drive input; and
a low boost circuit having a low boost input and a low boost output, wherein the low boost input is coupled to the input voltage terminal, the low boost output is coupled to the drive input;
wherein a voltage provided at the low boost output is lower than a voltage provided at the high boost output.

12. The control circuit of claim 11, wherein:
the low boost circuit is a single-stage charge pump circuit that is enabled only while the control circuit is operating in a standby mode; and
the high boost circuit includes a first charge pump stage, a second charge pump stage, and a third charge pump stage, wherein the first charge pump stage, second charge pump stage, and third charge pump stage are cascaded in series, and the high boost circuit is enabled only while the control circuit is operating in a normal mode.

13. The control circuit of claim 11, wherein:
the high boost circuit includes a first charge pump stage, a second charge pump stage, and a third charge pump stage, wherein the first charge pump stage, second charge pump stage, and third charge pump stage are cascaded in series, and the high boost circuit is enabled only while the control circuit is operating in a normal mode; and
the low boost circuit includes only the first charge pump stage, and the low boost circuit is enabled only while the control circuit is operating in a standby mode.

14. The control circuit of claim 11, further comprising a resistor coupled between a battery supply terminal and the input voltage terminal.

15. The control circuit of claim 14, further comprising a voltage clamp circuit coupled between the input voltage terminal and a ground terminal.

16. The control circuit of claim 15, wherein the voltage clamp circuit includes a zener diode.

17. The control circuit of claim 15, further comprising a capacitor coupled between the input voltage terminal and the ground terminal.

18. The control circuit of claim 11, wherein the drive output is configurable to be coupled to a control terminal of a transistor.

19. The control circuit of claim 11, further comprising a capacitor coupled between the input voltage terminal and the low boost input.

20. The control circuit of claim 11, wherein the control circuit is included in a voltage converter circuit.
